(19) United States
(12) Patent Application Publication
(10) Pub. No.: US 2015/0199751 A1
(43) Pub. Date: Jul. 16, 2015

(54) SYSTEM AND METHOD FOR A VIRTUAL STOREFRONT

(71) Applicant: Twentieth Century Fox Home Entertainment LLC, Los Angeles, CA (US)

(72) Inventor: Frank Bryant, San Marino, CA (US)

(21) Appl. No.: 14/420,119

(22) PCT Filed: Aug. 7, 2013
(86) PCT No.: PCT/US2013/053886

§ 371 Date: Feb. 6, 2015

Related U.S. Application Data
(60) Provisional application No. 61/680,445, filed on Aug. 7, 2012.

(51) Int. Cl. G06Q 30/06

(52) U.S. Cl. CPC G06Q 30/0643

(57) ABSTRACT

A system and method for a virtual storefront are provided, including a visual representation of a product, wherein said representation includes an image portion or code that is recognizable by a mobile device, whereupon such recognition facilitates purchase of the item represented in the display.

### BACKGROUND

The present disclosure relates to a system and method for a virtual storefront. More particularly, the present disclosure relates to systems and methods that display representations of products that include an image portion or code that is recognizable by a mobile device, whereupon such recognition facilitates purchase of the item represented in the display.

Traditional retail requires substantial resources, including real estate, stored inventory on hand, on-site employees and inventory management, among others. Inventory management, especially with high-cost and highly perishable goods, such as DVDs and other products, is expensive and risky. At the same time, shelf space is at a premium in many of the world markets for all goods. Further, in crowded areas, the requirement of a physical location, interaction with employees, payment and packaging, etc. can create long wait times before a transaction can be made.

What is needed in the art are systems and methods that eliminate such costly resources and, at the same time, provides a consumer an easy and fast mechanism for making transactions.

### SUMMARY

The above described problems and disadvantages in the art are overcome or alleviated by the present system and method for a virtual storefront, including a visual representation of a product, wherein said representation includes an image portion or code that is recognizable by a mobile device, whereupon such recognition facilitates purchase of the item represented in the display.

In one exemplary embodiment, the product representation is in print form. Exemplary print representations may be produced on any convenient surface, such as posters, walls, billboards, signs, furniture, distributed print media, labels and advertisements, among others.

In other exemplary embodiments, the product representation is in digital form. Exemplary display of digital representations may be via digital displays, projection displays, via broadcast, in a digital display advertising space, in digital cinema, online and via any point to multi-point broadcast application, among others. Such exemplary digital representations may be static, dynamic, periodically refreshed, navigable, etc.

In exemplary embodiments a mobile device is configured to scan or capture a portion of the visual representation. Software on the mobile device either recognizes the image portion or forwards the image portion to another site for recognition, e.g., an online vendor site. The image portion can be some or all of the visual representation, which in the case of DVD sales may be, e.g., a dvd cover, still shot, title, etc., among others. Thus the visual representation may be any image that is associated with a particular product.

In further exemplary embodiments, the visual representation may include a code that further identifies the product when scanned by a mobile device. Such code may be, for example, a bar code, a QR code (Quick Response Code), short code or other data or image, among others. Exemplary embodiments also place instructions or addresses within the code, such that when the code is scanned by a mobile device, the mobile device automatically launches appropriate software and/or connects with a networked online site to facilitate a purchase of the product represented by the visual representation.

Exemplary embodiments also provide network servers or engines that automatically process the data sent to the server or engine by the mobile device and process a purchase, e.g., by automatically placing an item in a shopping cart, by navigating to a page listing the product, by automatically, or with mobile device user verification, purchasing the product with user account information, such as PayPal, mobile device account data, or other user account data. In further exemplary embodiments, the products are shipped or made available at a location after such purchase is processed without further intervention by the mobile device user.

In further exemplary embodiments, the representation may be positioned within an existing store, either as an independent purchase system, or as part of a system that is tied into the existing store's purchase and product inventory system.

The above discussed and other features and advantages of the present invention will be appreciated and understood by those skilled in the art from the following detailed description and drawings.

### BRIEF DESCRIPTION OF THE DRAWINGS

Referring now to the drawings, wherein like elements are numbered alike in the following FIGURES:

FIG. 1 is an exemplary system diagram for a virtual storefront;

FIG. 2 is another exemplary system diagram for a virtual storefront;

FIG. 3 is a flowchart for a method for a virtual storefront;

FIG. 4a is an exemplary bus stop virtual storefront;

FIG. 4b is a close-up of the display for the virtual storefront illustrated in FIG. 4a;

FIG. 5 is another exemplary waiting stop for a virtual storefront; and

FIG. 6 is an exemplary virtual storefront provided as part of a magazine.

### DETAILED DESCRIPTION

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be further understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure.

As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, components and/or groups, but do not preclude the presence or addition of one or more other features, integers, steps, operations, elements, components, and/or groups thereof.

It will also be understood that the terms “photo,” “photograph,” “image,” “screen shot” or any variation thereof may be interchangeable. Thus, any form of graphical image may be applicable to example embodiments.

It will also be understood that the terms “statistics,” “measurements,” “analytics,” “calculations,” or other similar terms may be used to describe example forms of the associated definitions as understood by one of ordinary skill in the art, although other similar acts/functions may be applicable depending upon any particular form of an example embodiment. For example, a statistical calculation may include analytical calculations, and vice versa. Furthermore, measurements may include calculations upon, during, subsequent, or in addition to measurements or any act of retrieving data.

It should also be understood that other terms used herein may be applicable based upon any associated definition as understood by one of ordinary skill in the art, although other meanings may be applicable depending upon the particular context in which terms are used.

Therefore, the terminology used herein is for the purpose of describing particular embodiments only and is not intended to be limiting of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Further to the brief description provided above and associated textual detail of each of the figures, the following description provides additional details of example embodiments of the present invention.

As has been described above, the present disclosure provides a system and method for a virtual storefront, including a visual representation of a product, wherein said representation includes an image portion or code that is recognizable by a mobile device, whereupon such recognition facilitates purchase of the item represented in the display.

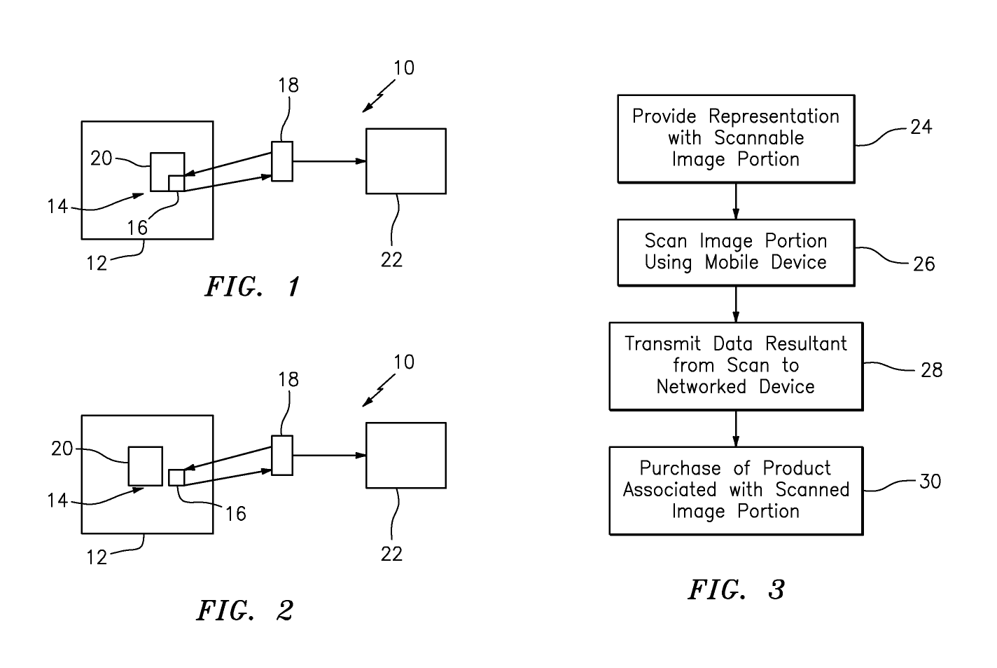

Reference is made to FIG. 1, which shows an exemplary system for a virtual storefront generally at 10. The exemplary system includes a display 12 that shows an image 14, which is shown generally at 14. A portion 16 of the image 14 is recognizable by a mobile device 18 when scanned or captured.

As used herein, image 14 may include one or more separate or overlapping images. FIG. 2 illustrates a system wherein the image 14 includes a recognizable image portion 16 as well as other associated image portions 20 that are not joined or overlapping.

Also, as used herein, the terms “scan” and “capture” are used alternatively, since a mobile device may be configured to recognize an image portion 16 via scan or image capture.

A networked device 22 is configured to process data received from the mobile device 18 relevant to the image portion 16 recognition and to facilitate purchase of a product corresponding to the recognized image portion 16.

Referring now to FIG. 3, an exemplary method includes: 24, providing a representation with a scannable (or otherwise recognizable) image portion; 26, scanning (or otherwise recognizing) the image portion using a mobile device; 28, transmitting data resultant from the image recognition to a networked device; and 30, purchase of a product associated with the recognized image portion.

In one exemplary embodiment, the product representation is in print form. Exemplary print representations may be produced on any convenient surface, such as posters, walls, billboards, signs, furniture, distributed print media, labels and advertisements, among others. In such cases, the print forms comprise the “display,” which contains the recognizable image portions.

In exemplary embodiments a mobile device is configured to scan or capture a portion of the visual representation. Software on the mobile device either recognizes the image portion or forwards the image portion to another site for recognition, e.g., an online vendor site. The image portion can be some or all of the visual representation, which in the case of DVD sales may be, e.g., a dvd cover, still shot, title, etc., among others. Thus the visual representation may be any image that is associated with a particular product.

In further exemplary embodiments, the visual representation may include a code that further identifies the product when scanned by a mobile device. Such code may be, for example, a bar code, a QR code (Quick Response Code), short code or other data or image, among others. Exemplary embodiments also place instructions or addresses within the code, such that when the code is scanned by a mobile device, the mobile device automatically launches appropriate software and/or connects with a networked online site to facilitate a purchase of the product represented by the visual representation.

Exemplary embodiments also provide network servers or engines that automatically process the data sent to the server or engine by the mobile device and process a purchase, e.g., by automatically placing an item in a shopping cart, by navigating to a page listing the product, by automatically, or with mobile device user verification, purchasing the product with user account information, such as PayPal, mobile device account data, or other user account data. In further exemplary embodiments, the products are shipped or made available at a location after such purchase is processed without further intervention by the mobile device user.

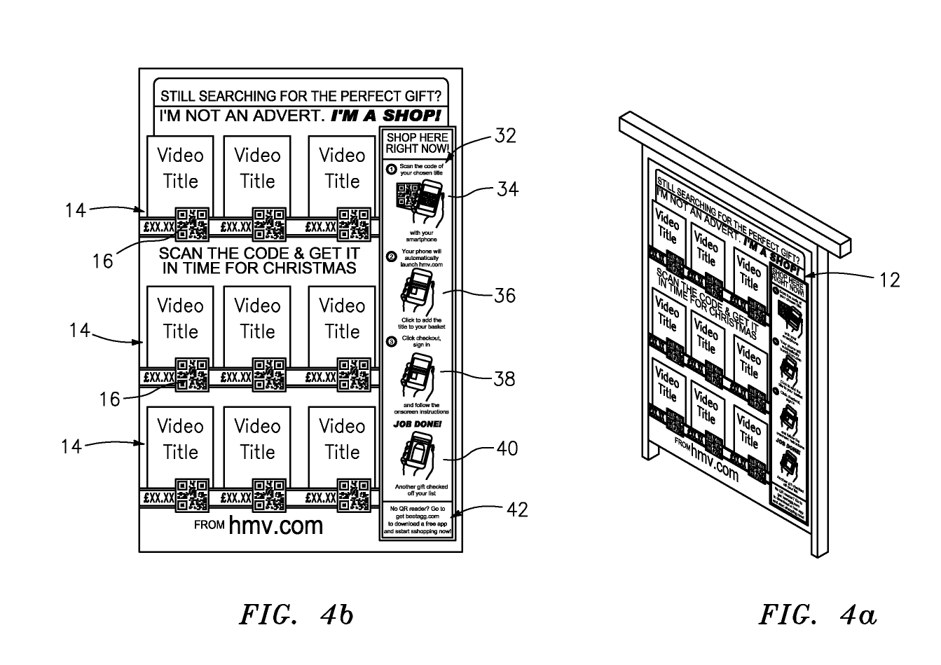

FIGS. 4a and 4b illustrate an exemplary print form, wherein the display 12 is part of a bus stop wall. FIG. 4b is a close-up of the printed display of FIG. 4a. The display 12 includes plural images 14 representative of DVDs that are available for purchase. Each image 14 includes a recognizable image portion 16, which in this case is a QR code (Quick Response Code). A methodology is also illustrated in the display generally at 32, including: 34, scanning the code of the chosen title with a smartphone; 36, automatic launch of a vendor website (hmv.com) with an option to add the DVD to a shopping basket; 38, an option to checkout; and 40 an indication of a completed purchase. The display 12 in FIGS. 14a and 14b also include instructions or links, shown generally at 42, to receive an appropriate QR code reader for the smartphone.

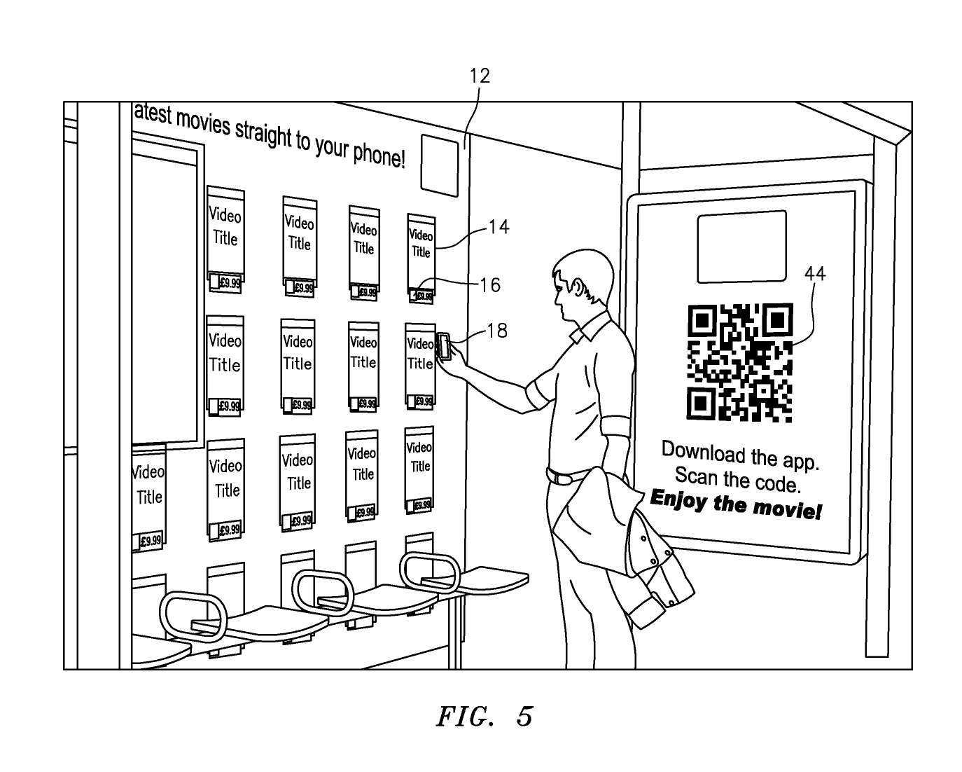

FIG. 5 illustrates another exemplary waiting stop display 12, with plural images 14 and recognizable image portions (QR codes) 16. A user is illustrated with a mobile device 18 positioned to recognize a QR code. In this embodiment, a separate display includes a QR code 44 for downloading an appropriate application, in a similar manner as 42 in FIGS. 4a and 4b.

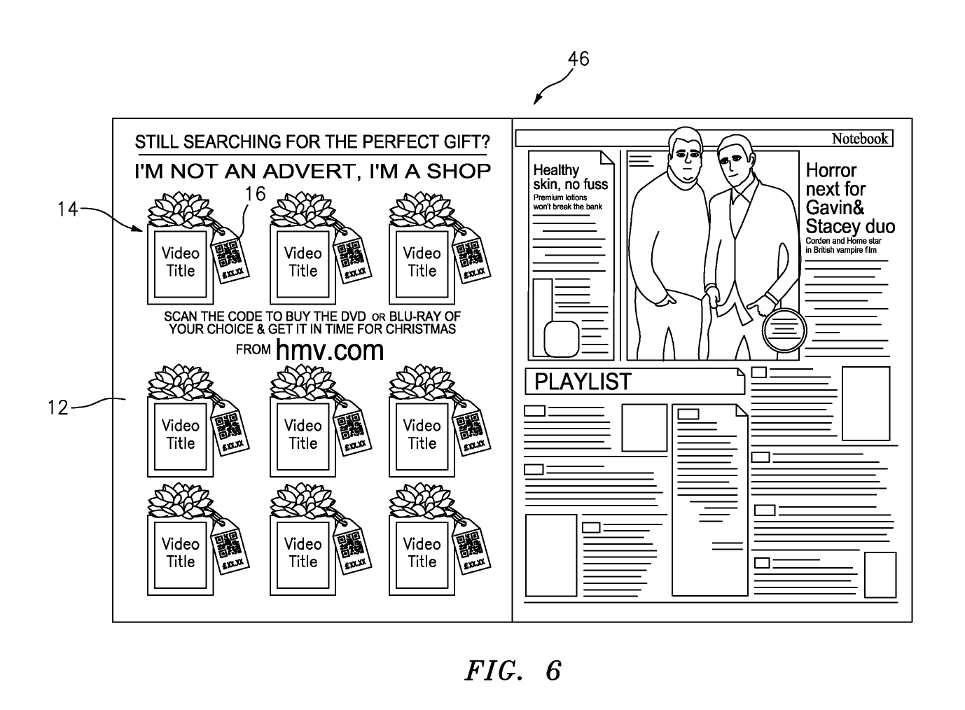

FIG. 6 illustrates another exemplary printed embodiment, this one as a page (corresponding to display 12) in a magazine, which is shown generally at 46. As in other exemplary embodiments, the display page 12 includes images 14 and recognizable image portions (QR codes) 16.

In other exemplary embodiments, the product representation is in digital form. Exemplary display of digital representations may be via digital displays, projection displays, via broadcast, in a digital display advertising space, in digital cinema, online and via any point to multi-point broadcast application, among others. Such exemplary digital representations may be static, dynamic, periodically refreshed, navigable, etc. A device, either the digital display device responding to user interaction, or a mobile device recognizes (by scan, capture or other method) the recognizable image portion and communicates with a networked device to effect purchase of a product associated with the recognizable image portion.

In further exemplary embodiments, the representation may be positioned within an existing store, either as an independent purchase system, or as part of a system that is tied into the existing store's purchase and product inventory system.

Exemplary embodiments described above advantageously provide a store where none existed before (as a virtual store). As is described above, an exemplary system may include one or more of: print and/or digital representations of products; bar code, QR code, short code or other data or image; a QR scanner, image recognition application or other application that can used by smart phones; back end software capable of interpreting data sent by smart phones; back end commerce, text, or video servers; and back end inventory management capable of serving new virtual inventory to digital versions of the virtual store, among others.

Exemplary embodiments advantageously provide a store as a space efficient, inventory-free system and method of creating shelf space to transact where no shelf space existed before. The system can be used by traditional retailers (to sell product with less floor space), non-traditional retailers (who would like to sell goods without inventory risk), public display space owners (such as billboard owners), print media owners, and advertisers. Because this new shelf space includes only virtual goods, inventory risk is eliminated. Exemplary embodiments of the virtual storefront also create a new way to transact on-the-go where consumers experience long wait times (e.g., lines at the bank or in coffee houses) but have no means of transacting.

The versatility of possible placement or distribution of the virtual store “display” also provides great advantage in and of itself and with reference to particular venues, e.g., placement adjacent or proximate feature film advertisement will enhance film attendees experience at the theater and also serve as an source of impulse purchase for viewers who wish to acquire additional films from the same production team, director or actors.

Thus, exemplary embodiments of the virtual storefront provide mechanisms for increased sales and margins without requiring shelf space, with lower inventory risk, and with the ability to place products advantageously, e.g., as advertising within a venue.

It is further noted that embodiments of the invention may be embodied in the form of computer-implemented processes and apparatuses for practicing those processes. Therefore, according to an exemplary embodiment, the methodologies described hereinbefore may be implemented by a computer system or apparatus. Portions or the entirety of the methodologies described herein may be executed as instructions in a processor of the computer system. The computer system includes memory for storage of instructions and information, input device(s) for computer communication, and display device. Thus, the present invention may be implemented, in software, for example, as any suitable computer program on a computer system somewhat similar to computer system. For example, a program in accordance with the present invention may be a computer program product causing a computer to execute the exemplary methods described herein.

Therefore, embodiments can be embodied in the form of computer-implemented processes and apparatuses for practicing those processes on a computer program product. Embodiments include the computer program product as depicted in on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should be emphasized that the above-described example embodiments of the present invention, including the best mode, and any detailed discussion of particular examples, are merely possible examples of implementations of example embodiments, and are set forth for a clear understanding of the principles of the invention. Many variations and modifications may be made to the above-described embodiment(s) of the invention without departing from the spirit and scope of the invention. All such modifications and variations are intended to be included herein within the scope of this disclosure and the present invention and protected by the following claims.

What is claimed is:

1. A method for providing a virtual storefront, comprising:
providing a visual representation of a product on a display, the visual representation being configured with an image portion that is recognizable by a mobile device;
recognizing said image portion on said display utilizing said mobile device; and
transmitting from said mobile device data resultant from said recognition of said image portion to a networked device to effect purchase of said product.

2. A method in accordance with claim 1, wherein said image portion is configured to be scanned by said mobile device.

3. A method in accordance with claim 2, wherein said image portion is one or more of a bar code, a QR code (Quick Response Code), and a short code.

4. A method in accordance with claim 2, wherein said mobile device is configured with software that is configured to transmit said data subsequent to mobile device recognition of said image portion.

5. A method in accordance with claim 3, wherein said mobile device is configured to transmit said data in response to scanning of a QR code that is provided as said image portion.

6. A method in accordance with claim 1, wherein said networked device comprises an online server that is configured to process a request for purchase of said product resultant from said image portion recognition on said mobile device.

7. A method in accordance with claim 6, wherein said networked device prompts said mobile device to confirm purchase after receipt of said data and prior to purchase of said product.

8. A method in accordance with claim 1, wherein said networked device comprises a networked server of a physical retail store in which said display is positioned.

9. A method in accordance with claim 8, wherein said networked server confirms purchase of a product and allocates a corresponding inventory to said mobile device or user of said mobile device.

10. A method in accordance with claim 1, wherein said display is a digital display.

11. A method in accordance with claim 10, wherein said display is one or more of a digital monitor display, a projection display, a broadcast display, a digital display advertising display, and a digital cinema display.

12. A method in accordance with claim 10, wherein said digital display is configured to be refreshed with new image content at a predetermined interval.

13. A method in accordance with claim 10, wherein said digital display is configured to be navigable by a user, such that the user can access content that is not viewable on said display at a given moment in time.

14. A method in accordance with claim 1, wherein said display is printed.

15. A method in accordance with claim 14, wherein said printed display comprises one or more of a poster, a wall, a billboard, a sign, a piece of furniture, a distributed print media, a label and an advertisement.

16. A system for providing a virtual storefront, comprising:
a visual representation of a product on a display, the visual representation being configured with an image portion that is recognizable by a mobile device; and
a networked device configured to receive a data transmission from a mobile device resultant from recognition of said image portion by said mobile device and to effect purchase of said product related to said data transmission.

17. A system in accordance with claim 16, wherein said image portion is configured to be scanned by said mobile device.

18. A system in accordance with claim 17, wherein said image portion is one or more of a bar code, a QR code (Quick Response Code), and a short code.

19. A system in accordance with claim 17, wherein said mobile device is configured with software that is configured to transmit said data subsequent to mobile device recognition of said image portion.

20. A system in accordance with claim 18, wherein said mobile device is configured to transmit said data in response to scanning of a QR code that is provided as said image portion.

21. A system in accordance with claim 16, wherein said networked device comprises an online server that is configured to process a request for purchase of said product resultant from said image portion recognition on said mobile device.

22. A system in accordance with claim 21, wherein said networked device prompts said mobile device to confirm purchase after receipt of said data and prior to purchase of said product.

23. A system in accordance with claim 16, wherein said networked device comprises a networked server of a physical retail store in which said display is positioned.

24. A system in accordance with claim 23, wherein said networked server is configured to confirm purchase of a product and allocate a corresponding inventory to said mobile device or user of said mobile device.

25. A system in accordance with claim 16, wherein said display is a digital display.

26. A system in accordance with claim 25, wherein said display is one or more of a digital monitor display, a projection display, a broadcast display, a digital display advertising display, and a digital cinema display.

27. A system in accordance with claim 25, wherein said digital display is configured to be refreshed with new image content at a predetermined interval.

28. A system in accordance with claim 25, wherein said digital display is configured to be navigable by a user, such that the user can access content that is not viewable on said display at a given moment in time.

29. A system in accordance with claim 16, wherein said display is printed.

30. A system in accordance with claim 29, wherein said printed display comprises one or more of a poster, a wall, a billboard, a sign, a piece of furniture, a distributed print media, a label and an advertisement.
